(19) United States
(12) Patent Application Publication
(10) Pub. No.: US 2018/0366782 A1
(43) Pub. Date: Dec. 20, 2018

(54) BATTERY HAVING RETICULATED POSITIVE AND NEGATIVE ELECTRODE STRUCTURES AND HAVING A CHARGING CONTROLLER TO ENHANCE CRYSTALLINE GROWTH AND METHOD THEREFOR

(71) Applicants: Jonathan Jan, Culver CIty, CA (US); Alvin Snaper, Las Vegas, NV (US)

(72) Inventors: Jonathan Jan, Culver CIty, CA (US); Alvin Snaper, Las Vegas, NV (US)

(21) Appl. No.: 16/008,485

(22) Filed: Jun. 14, 2018

Related U.S. Application Data
(60) Provisional application No. 62/520,321, filed on Jun. 15, 2017.

(51) Int. Cl. H01M 10/0565; H01M 10/0585; H01M 10/44; H01M 10/42; H01G 11/08; H02J 7/00

(52) U.S. Cl. CPC H01M 10/0565; H01M 10/0585; H01M 10/44; H01M 2300/0082; H01G 11/08; H02J 7/007; H02J 7/0042; H01M 10/4264

(57) ABSTRACT

An electrochemical battery having an electrolyte. A pair of reticulated electrode plates is positioned within the electrolyte. A separator is positioned between the pair of reticulated electrode plates.

### RELATED APPLICATIONS

This patent application is related to U.S. Provisional Application No. 62/520,321 filed Jun. 15, 2017, entitled “BATTERY HAVING RETICULATED POSITIVE AND NEGATIVE ELECTRODE STRUCTURES AND HAVING A CHARGING CONTROLLER TO ENHANCE CRYSTALLINE GROWTH AND METHOD THEREFOR” in the name of the same inventors, and which is incorporated herein by reference in its entirety. The present patent application claims the benefit under 35 U.S.C § 119(e). This application is also related to U.S. patent application Ser. No. 15/197,561 filed on Jun. 29, 2016, in the name of the same inventors as the present application, and which is incorporated by reference into the present application.

### TECHNICAL FIELD

The present application generally relates to a battery, and more specifically, to battery having reticulated positive and negative electrode structures that increases the reacting surface area thereby increasing the capacity and efficiency of the battery, and which has a charging controller. Internal to the battery to enhance effective crystalline growth on the electrode structures.

### BACKGROUND

Electrochemical batteries generally include pairs of oppositely charged plates (positive and negative), and an intervening electrolyte to convey ions from one plate to the other when the circuit through the battery is completed. The ability of the electrochemical battery to deliver electrical current is generally a straight-line function of the surface area of the plates which is contacted by the electrolyte. A flat plate constitutes a lower limit, which is frequently improved by sculpting the surface of the plate. For example, waffle shapes are known to have been used. However, there is a physical limitation to what can be done to “open-up” the surface of the plates, because the plates must resist substantial mechanical stringencies such as vibration and acceleration, and must be strongly supported at their edges. Thus, plates which are rendered delicate by casting or molding them into shapes which have thin sections are not a viable solution to increase the surface area of the plates. Further, such plates are subject to erosion and loss of material, thereby further reducing the strength of the plate over the life of the battery. A tempting solution is to use a woven screen for a plate. However, screens can be bent, usually on two axes. Especially after significant erosion they do not have sufficient structural strength. A battery is destroyed if a screen or plate collapses or contacts a neighboring screen/plate.

Despite the inherent potential structural disadvantages, it is a valid objective to attempt to increase the area exposed to the electrolyte by giving access to interior regions of a plate in order to increase the capacity and efficiency of the electrochemical battery. Otherwise the entire interior of the plate serves as no more than an electrical conductor and support for the surface of the plate. Holes through the plate can in fact increase surface area by the difference between their area removed from the surface and the added area of their walls. However, there is an obvious limitation to this approach.

A benefit in addition to increased surface area which could be obtained with an open-structured plate is the storage of electrolyte within the envelope of the plate. In turn, for a given amount of electrolyte volume, the gross volume of the battery can be reduced by the amount which is stored in the plates, rather than in the spacing between plates. Evidently the problem is one of increasing the surface area of the plates without compromising their strength.

Snaper, in U.S. Pat. No. 6,060,198 describes reticulated metal structures as plates for used as electrodes in the electrochemical battery. The reticulated structure consists of a plurality of pentagonally faced dodecahedrons. The reticulated metal structure is able to increase the capacity and efficiency of electrochemical batteries, while reducing the weight and unusable metals of the battery. However, the cost of making such metal forms may be cost prohibitive for commercial production. Further, depositing metals on the reticulated polymer substrate is difficult. Vacuum plating, plasma deposition and other methods may only deposit thick coats of metal on the bearing surface. Thus, the mortal may not be able to penetrate deep into the core of the substrate, thereby limiting the reacting surface area within the core of the substrate.

Snaper, Ser. No. 15/197,561, filed on Jun. 29, 2016 discloses a method of forming a reticulated plate for an electrode in an electrochemical battery. The method coats a reticulated substrate with a conductive material. The reticulated substrate coated with the conductive material is then cured. Next, one may electroplate the reticulated substrate coated with the conductive material with a desired metal material. While the above method may significantly improve the surface area and additional electrolyte capacity, deposition processes are limited to the negative electrode of a lead-acid battery. Positive electrodes of the lead-acid battery are still limited to pressed material due to manufacturing difficulties.

During the charging cycle of a chemical battery after it has been discharged, one generally plates the metals back onto the negative electrode plate. For electrolyte batteries, the recharging process is similar to electroplating. Electrons are fed to the negative electrode plate where metallic ions in the electrolyte are reduced back to atomic phase and redeposit onto the surface of the negative electrode plate. Traditional battery chargers apply Direct Current (DC) current to the battery. When an excessive DC current is applied to the battery, overheating and crystallization cause irreversible damages to the battery. Due to the local oversaturation of salt ions near the separator (a permeable membrane between the positive and negative electrode plates), salt crystals may form which may clog up the passage on the separator and eventually precipitate to the bottom of the battery cell. Meanwhile, excessive amorphous metal atoms accumulate at the surface of the electrode plates and precipitate to the bottom of the battery cell. This process eventually shorts out the battery cell.

Therefore, it would be desirable to provide a system and method that overcomes the above. The system and method would provide reticulated electrodes for both positive and negative plates of the lead-acid battery. The system and method would increase surface area and electrolyte capacity of the both positive and negative electrode plates of the lead-acid battery. The system and method would improve the recharging process of the battery. The system and method would control the sending of clusters (packets) of electrons and ions towards the electrode plate for effective crystalline growth on the electrode plates during the charging process.

### SUMMARY OF THE INVENTION

In accordance with one embodiment, an electrochemical battery is disclosed. The electrochemical battery has an electrolyte. A pair of reticulated electrode plates is positioned within the electrolyte. A separator is positioned between the pair of reticulated electrode plates.

In accordance with one embodiment, an electrochemical battery is disclosed. The electrochemical battery has an electrolyte. A pair of reticulated electrode plates is positioned within the electrolyte. A separator is positioned between the pair of reticulated electrode plates. A charging controller is coupled to the pair of reticulated electrode plates selecting a specific reticulated electrode plate to charge and controlling a charging current.

In accordance with one embodiment, an electrochemical battery is disclosed. The electrochemical battery has an electrolyte. A pair of reticulated electrode plates is positioned within the electrolyte. A separator is positioned between the pair of reticulated electrode plates. A charging controller is coupled to the pair of reticulated electrode plates selecting a specific reticulated electrode plate to charge and controlling a charging current. A supercapacitor coupled in parallel with the electrochemical battery. The electrolyte comprises a dilute sulphuric acid (H₂SO₄), Polyvinyl Alcohol (PVA) forming a gel electrolyte, HEC (hydroxyethylcellulose), Iminodisuccinic acid (IDS), wherein the PVA and HEC react in the H₂SO₄ forming a 3-dimensional polymeric network.

### BRIEF DESCRIPTION OF THE DRAWINGS

The present application is further detailed with respect to the following drawings. These figures are rot intended to limit the scope of the present application but rather illustrate certain attributes thereof. The same reference numbers will be used throughout the drawings to refer to the same or like parts.

FIG. 1 is a front view of a battery made in accordance with an embodiment of the present invention.

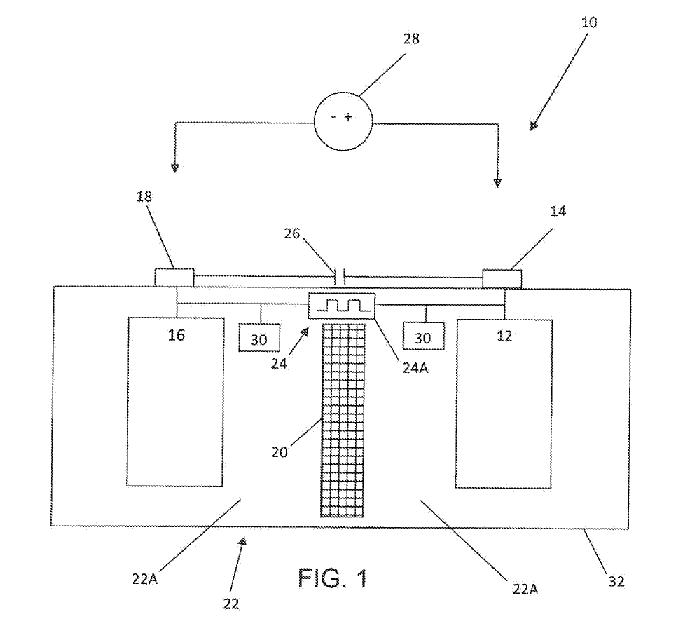

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a reticulated electrode structure for use in an electrochemical battery. The system and method would provide reticulated electrodes for both positive and negative electrodes of a lead-acid battery. The system and method would improve the recharging process of the battery. The system and method would control the sending of clusters (packets) of electrons and ions towards the electrode for effective crystalline growth on the electrode plates during the charging process.

The components of a lead-acid battery 10 may comprise an electrode plate 12 (i.e., cathode), which may connect to the positive terminal 14, and an electrode plate 16 (i.e., anode), which may connect to the negative terminal 18. A separator 20 creates a barrier between the electrode plates 12 and 16, preventing the electrode plates 12 and 16 from touching while allowing electrical charge to flow freely between them. An electrolyte 22 is provided that may allow an electric charge to flow between the two electrode plates 12 and 16 (i.e., between the cathode and anode). The electrode plate 12 and 16, the separator 20 and electrolyte 22 may be placed in a sealed housing 32.

When a load is attached between the positive 14 and negative 18 terminals, the battery 10 produces electricity through a series of electromagnetic reactions between the electrode plates 12 and 16 (i.e., the anode acid cathode) and the electrolyte 22. The negative electrode plate 16 (i.e., anode) experiences an oxidation reaction in which two or more ions (electrically charged atoms or molecules) from the electrolyte 22 combine with the positive electrode plate 12 (i.e. cathode), producing a compound and releasing one or more electrons. At the same time, the positive electrode plate 12 (i.e., cathode) goes through a reduction reaction in which the positive electrode plate 12, ions and free electrons combine to form compounds. Thus, the reaction in the negative electrode plate 16 (i.e., anode) creates electrons, and the reaction in the positive electrode plate 12 (i.e., cathode) absorbs them. The net product is electricity. The battery 10 will continue to produce electricity until one or both of the electrodes 12 and/or 16 run out of the substance necessary for the reactions to occur.

To recharge the battery 10, an external DC source 28 may be applied to the battery 10. The negative terminal of the DC source 28 is connected to the negative electrode plate 16 (i.e., anode) of the battery 10 and the positive terminal of the DC source is connected to the positive electrode plate 12 (i.e., cathode) of the battery 10.

Due to the external DC source 28, electrons may be injected in the negative electrode plate 16 (i.e., anode). The electrons are fed to the negative electrode plate 16 (i.e. anode) where metallic ions in the electrolyte are reduced back to atomic phase and redeposit onto the surface of the negative electrode plate 16 (i.e., anode) and return to its previous state when the battery 10 was not discharged.

As the positive terminal of the DC source 28 is connected to the positive electrode plate 12 (i.e. cathode), the electrons of the positive electrode plate 12 (i.e., cathode) will be attracted by this positive terminal of DC source. As a result, oxidation reaction takes place at the positive electrode plate 12 (i.e., cathode) and cathode material regains its previous state when it was not discharged.

Snaper, in U.S. Pat. No. 6,060,198 and in his application having Ser. No. 15/197,561, describes reticulated structures for used as electrodes in the electrochemical battery. However, the above processes disclosed are generally limited to the negative electrode plate of a lead-acid battery. Positive electrode plates of the lead-acid battery are still limited to pressed material due to manufacturing difficulties.

Let us now consider a single storage battery cell made up of electrolyte, one positive electrode plate, and one negative electrode plate. When the battery cell is fully charged, or condition to produce a current of electricity, the positive electrode plate 12 may be made up of peroxide of lead (PbO₂), the negative electrode plate 16 of pure lead (Pb), and the electrolyte 22 of dilute sulphuric acid (H₂SO₄).

The chemical changes that take place when the battery cell is discharging may be shown by the following:

At the Positive Electrode Plate 12: Lead peroxide and sulphuric acid produce lead sulphate, water, and oxygen, or:

PbO₂+H₂SO₄=PbSO₄+H₂O+O (a).

The positive electrode plate 12 is a mixture of lead oxides, since PbO₂ is electrically non-conductive.

At the Negative Electrode Plate 16: Lead and sulphuric acid produce lead sulphate and Hydrogen, or:

Pb+H₂SO₄=PbSO₄+H₂ (b).

In accordance with one embodiment of the present invention, one may make the positive electrode plate form a reticulated negative electrode plate via a discharging then recharging process in a half-cell environment. This is possible because of the unique duality of the electrodes when fully discharged. Both plates become PbSO₄ as shown in the above equations.

A half-cell reaction is either an oxidation reaction in which electrons are lost, or a reduction reaction where electronic are gained. The reactions occur in an electrochemical cell which the electrons are lost at the negative electrode plate (anode) through oxidation and consumed at the positive electrode plate (i.e., cathode) where the reduction occurs. When the reticulated negative electrode plate is recharged as the positive electrode plate from the reticulated negative electrode plate, it is reverted into PbO₂ and other conductive lead-oxides. This is by the principle of self-organization, the natural way. The benefit is having reticulated electrodes for both positive and negative electrode plates. By having reticulated electrodes for both positive and negative electrode plates one may yield maximum surface area and electrolyte capacity.

Thus, in accordance with one embodiment of the present invention, the electrode plate 12 and 14 may both be reticulated electrode plates 12A and 14A. The reticulated electrode plates 12A and 14A may be formed in a similar manner as described in U.S. patent application. Ser. No. 15/197,561 filed on Jun. 29, 2016, in the name of the same inventors as the present application and which is incorporated herewith by reference.

In order to more effectively and efficiently charge the battery, a charging controller 24 may be used. The charging controller 24 may be programmed to select the specific electrode a disclosed above. The charging controller 24 may be programmed to enhance charging efficiency. Traditional battery chargers are analog in design. These battery chargers may apply Direct Current (DC) current to the battery being charged. While some prior art battery chargers may allow pulse signals to be used in charging, these battery chargers are still analog in design which are being driven by a DC current.

In accordance with one embodiment, a digital charging controller 24A may be used. The digital charging controller 24A may be embedded in the battery 10. The digital charging controller 24A may be used to control the charging current. The digital charging controller 24A may be used to control the charging current whereby the charging current may be a programmed array of square waves instead of constant current in normal charging circuitry. The digital charging controller 24A may be programmed to deliver specific width of the square waves as well as the voltage. By delivering a square wave charging current, one may delivery specific clusters (packets) of electrons and ions through the electrolyte 22 towards the electrode for effective crystalline growth on the electrode plates 12 and/or 16. This may allows one to use much higher voltages during the charging process. This may allow for fast charging of the battery 10 without damaging the battery chemistry. This process is similar to electron-beam deposition. The type of waveform used may vary based on the type of battery being charged. This is due to the fact that the ionic behavior may be different for different types of batteries.

The digital charging controller 24A does not actually charge the battery 10. Instead, the digital charging controller 24A charges individual cells severally and collectively. Because of the crystalline growth process on the electrode plates 12 and/or 16, better structural strength and integrity is achieved. Hence the battery 10 can sustain more charging cycles. In accordance with one embodiment, one or more sensors 30 may be placed in each cell of the battery 10. The sensors 30 may be used to send feedback information to the digital charging controller 24A. The feedback information may be related to the current operating status of each cell, the information related to the charging process, as well as other operating conditions. The above is given as examples and should not be seen in a limiting manner. The sensors 30 may be used to provide other information without departing from the spirit and scope of the present invention.

The electrolyte 22 in the battery 10 may have to be adjusted to enhance the shooting of the clusters (packets) of electrons and ions through the electrolyte 22 towards the electrode 12 and/or 16 for effective crystalline growth on the electrodes 12 and/or 16. For example, an organic buffer may be added to the electrolyte 22. The organic buffer may be glycerol, sucrose, corn syrup, or other types of sugar based organic buffer. The organic buffer may be used to modify the Ph value of the electrolyte without affecting the chemical reaction within the battery 10. The organic buffer may be used to tweak the pH value in order to prevent a build-up of precipitation and particulates within a bottom of the battery 10. This can be done with both acid and alkaline battery electrolytes 22. Buffers can also be incorporated to prevent “tree-growing” on the electrode plates 12 and/or 16. “Tree growing” may refer to a situation where zinc deposition may be formed around or through the separator 20 which often leads to short circuiting of the electrodes 12 and 16.

In accordance with one embodiment, the electrolyte 22 may contain additives which may cause the electrolyte to congeal to form a gel like electrolyte 22A. Most gel like electrolytes 22A use Polyvinyl Alcohol (PVA) as thickening agent. The gel like electrolyte 22A may minimizes evaporation and leakage.

A chelating agent may be added to the gel like electrolyte 22A to increase the delivery efficiency of ions in the electrolyte. The use of chelating agents has been used as shown in U.S. Pat. No. 9,819,055. In U.S. Pat. No. 9,819,055, Ethylenediaminetetraacetic acid (EDTA) is used as a chelating agent. Unfortunately, EDTA is not biodegradable. It causes serious environmental hazard when discharged into the eco system. This chelating agent pulls heavy metals out of soil and distribute them in rivers and lakes.

In accordance with one embodiment, the gel like electrolyte 22A utilizes polyvinyl alcohol (PVA), HEC (hydroxyethylcellulose) and Iminodisuccinic acid (IDS) dissolved in sulfuric acid. PVA and HEC react in sulfuric acid to form a 3-dimensional polymeric network, which reduces the gel electrolyte's resistivity and maximizes ionic delivery efficiency. IDS is a bridgeable chelating agent which is environmentally safe.

Corn syrup may be added to the gel like electrolyte 22A. Corn syrup may act as a crystal-growth buffer. During the fast charging cycle, it inhibits “treeing” on the electrode plates 12 and/or 16. “Tree growing” may refer to a situation where zinc deposition may be formed around or through the separator 20 which often leads to short circuiting of the electrodes 12 and 16.

In accordance with one embodiment, the gel like electrolyte 22A may contain an electrolyte solution. The electrolyte solution may be a dilute sulphuric acid (H₂SO₄). The gel like electrolyte 22A may contain approximately 95%-98% by volume of the dilute sulphuric acid (H₂SO₄). The gel like electrolyte 22A may use PVA as thickening agent. In accordance with one embodiment, the gel like electrolyte 22A may contain approximately 0.5% to 1.5% by volume of PVA. The gel like electrolyte 22A may use HEC to react with the PVA in the H₂SO₄ to form a 3-dimensional polymeric network, which reduces the gel electrolyte's resistivity and maximizes ionic delivery efficiency. In accordance with one embodiment, the gel like electrolyte 22A may contain approximately 0.5% to 1.5% by volume of HEC. The gel like electrolyte 22A may use IDS as a bridgeable chelating agent. In accordance with one embodiment, the gel like electrolyte 22A may contain approximately 0.05% to 1% by volume of IDS. The gel like electrolyte 22A may use a buffer to enhance the shooting of the clusters (packets) of electrons and ions through the gel like electrolyte 22A towards the electrode 12 and/or 16 for effective crystalline growth on the electrodes 12 and/or 16. The buffer may be an organic buffer such as glycerol, sucrose, corn syrup, or other types of sugar based organic buffer. In accordance with one embodiment, the gel like electrolyte 22A may contain approximately 0.05% to 1% by volume of the buffer. In one embodiment the buffer is an organic buffer of corn syrup.

The battery 10 may be coupled to a bank of super capacitors 26. Supercapacitors 26 may be defined as high high-capacity capacitors with capacitance values much higher than other capacitors, but with lower voltage limits. Supercapacitors 26 may store 10 to 100 times more energy per unit volume or mass than electrolytic capacitors, can accept and deliver charge much faster than batteries, and tolerate many more charge and discharge cycles than rechargeable batteries.

A supercapacitor 26 may differ from an ordinary capacitor in two ways. First, the plates of the supercapacitor 26 may effectively have a much bigger area. Second, the distance between the plates in the supercapacitor 26 may be much smaller, because the separator between the plates works in a different way to a conventional dielectric.

The plates of the supercapacitor 26 may be made from metal coated with a porous substance such as powdery, activated charcoal, which may effectively give the plates a bigger area for storing more charge. In a supercapacitor 26, both plates may be soaked in an electrolyte and separated by a very thin insulator, which may be made of carbon, paper, plastic and similar material. When the plates are charged up, an opposite charge may form on either side of the separator, creating an electric double-layer.

In accordance with one embodiment, the supercapacitors 26 may be coupled in a parallel manner with the battery 10. The supercapacitors 26 may serve as a reserve current supply for surge demand, as well as regulated power-supply for the digital charging controller 24A. For example, in a lead-acid battery, the cell voltage may be 2 VDC while the battery voltage may be 12 VDC. The super-capacitor bank may be 12 VDC. Hence the digital charging controller 24A may have the flexibility of sending high voltage square waves for fast-charging without the risk of growing “trees” or precipitation, while slow or trickle charge is performed at much lower voltage.

The foregoing description is illustrative of particular embodiments of the application, but is not meant to be a limitation upon the practice thereof. The following claims, including all equivalents thereof, are intended to define the scope of the application.

What is claimed is:

1. An electrochemical battery comprising:
an electrolyte;
a pair of reticulated electrode plates positioned within the electrolyte; and
a separator positioned between the pan of reticulated electrode plates.

2. The electrochemical battery of claim 1, comprising a charging controller coupled to the pair of reticulated electrode plates to select a specific reticulated electrode plate to charge.

3. The electrochemical battery of claim 2, wherein the charging controller controls a charging current.

4. The electrochemical battery of claim 2, wherein the charging controller controls a charging current and charging voltage.

5. The electrochemical battery of claim 2, wherein the charging controller is a digital charging controller, the digital charging controller programmed to control a charging current, whereby the charging current is an array of square waves.

6. The electrochemical battery of claim 2, wherein the charging controller is a digital charging controller, the digital charging controller programmed to control a charging current, whereby the charging current is an array of square waves, the digital charging controller adjusting a width of the array of square waves.

7. The electrochemical battery of claim 1, comprising supercapacitors coupled in parallel with the electrochemical battery.

8. The electrochemical battery of claim 1, wherein the electrolyte comprises a dilute sulphuric acid (H₂SO₄) and Polyvinyl Alcohol (PVA) forming a gel electrolyte.

9. The electrochemical battery of claim 1, wherein the electrolyte comprises a dilute sulphuric acid (H₂SO₄), Polyvinyl Alcohol (PVA) forming a gel electrolyte, and Iminodisuccinic acid (IDS) used as a chelating agent.

10. The electrochemical battery of claim 1, wherein the electrolyte comprises a dilute sulphuric acid (H₂SO₄) Polyvinyl Alcohol (PVA) forming a gel electrolyte, HEC (hydroxyethylcellulose) and Iminodisuccinic acid (IDS), wherein the PVA and HEC react in the H₂SO₄ forming a 3-dimensional polymeric network.

11. The electrochemical battery of claim 1, wherein the electrolyte comprises a dilute sulphuric acid (H₂SO₄), Polyvinyl Alcohol (PVA) forming a gel electrolyte and a sugar based organic buffer.

12. The electrochemical battery of claim 11, wherein the sugar based organic buffer is corn syrup.

13. The electrochemical battery of claim 1, wherein the electrolyte comprises H₂SO₄ in a range of approximately 95%-98% by volume; PVA in a range of approximately 0.5% to 1.5% by volume, HEC in a range of approximately 0.5% to 1.5% by volume, IDS in a range of approximately 0.05% to 1% by volume and a sugar based organic buffer in a range of approximately 0.05% to 1% by volume.

14. An electrochemical battery comprising:
an electrolyte;
a pair of reticulated electrode plates positioned within the electrolyte;
a separator positioned between the pair of reticulated electrode plates; and
a charging controller coupled to the pair of reticulated electrode plates selecting a specific reticulated electrode plate to charge and controlling a charging current.

15. The electrochemical battery of claim 14, comprising a supercapacitor coupled in parallel with the electrochemical battery.

16. The electrochemical battery of claim 14, wherein the charging controller is a digital charging controller, the digital charging controller programmed to control a charging current, whereby the charging current is an array of square waves.

17. The electrochemical battery of claim 14, wherein the electrolyte comprises a dilute sulphuric acid (H₂SO₄), Polyvinyl Alcohol (PVA) forming a gel electrolyte, and Iminodisuccinic acid (IDS) used as a chelating agent.

18. The electrochemical battery of claim 14, wherein the electrolyte comprises a dilute sulphuric acid (H₂SO₄), Polyvinyl Alcohol (PVA) forming a gel electrolyte, HEC (hydroxyethylcellulose), Iminodisuccinic acid (IDS), wherein the PVA and HEC react in the H₂SO₄ forming a 3-dimensional polymeric network and a sugar based organic buffer.

19. An electrochemical battery comprising:
an electrolyte;
a pair of reticulated electrode plates positioned within the electrolyte;
a separator positioned between the pair of reticulated electrode plates;
a charging controller coupled to the pair of reticulated electrode plates selecting a specific reticulated electrode plate to charge and controlling a charging current; and
a supercapacitor coupled in parallel with the electrochemical battery.
wherein the electrolyte comprises a dilute sulphuric acid (H₂SO₄), Polyvinyl Alcohol (PVA) forming a gel electrolyte, HEC (hydroxyethylcellulose), Iminodisuccinic acid (IDS), wherein the PVA and HEC react in the H₂SO₄ forming a 3-dimensional polymeric network.

20. The electrochemical battery of claim 19, wherein the electrolyte comprises a sugar based organic buffer.
